(19) United States
(12) Patent Application Publication
(10) Pub. No.: US 2004/0122699 A1
(43) Pub. Date: Jun. 24, 2004

(54) Method and system for integrating workflow management with business intelligence

(75) Inventors: Vilosh M. Brito, Auckland (NZ); Philip M. Jordan, Auckland (NZ); Keith S. Ng, Auckland (NZ); David Kennett, Auckland (NZ)

Correspondence Address: NIXON & VANDERHYE, PC, 1100 N GLEBE ROAD, 8TH FLOOR, ARLINGTON, VA, 22201-4714, US

(73) Assignee: DESCISYS LTD., Auckland (NZ)

(21) Appl. No.: 10/732,457

(22) Filed: Dec. 11, 2003

(30) Foreign Application Priority Data
Dec. 13, 2002 (NZ) 523144

(51) Int. Cl. G06F 17/60

(52) U.S. Cl. 705/1

(57) ABSTRACT

The present invention relates to a method for integrating workflow management with business intelligence. More particularly, but not exclusively, the present invention relates to a method for defining a workflow for processes. A plurality of processes 26, at least one of the processes including a business intelligence module (FIGS. 25 to 30), are specified within a GUI (FIG. 4). Directed links 27 between the processes are specified within the GUI. The present invention further relates to a method for executing processes in a workflow. A plurality of processes 62, at least one of the processes including a business intelligence module (FIGS. 25 to 30), and directed links 60 between the processes are displayed in a GUI (FIG. 16). The processes are executed 57 in sequence. A system for integrating workflow management with business intelligence is also disclosed.

### FIELD OF INVENTION

The present invention relates to a method and system for integrating workflow management with business intelligence. More particularly, but not exclusively, the present invention relates to a method and system for defining and executing a workflow which includes at least one business intelligence module.

### BACKGROUND TO THE INVENTION

Business intelligence systems take data from, typically, a multitude of data sources or data warehouses and compile the data into first tier databases such as relational databases and/or multidimensional databases. Tools are provided by the business intelligence systems to analyse and process this data. These tools include applications such as budgeting, consolidation and analytical applications.

Business intelligence systems include systems commonly called OLAP systems as discussed in BUSINESS INTELLIGENCE LTD's THE OLAP REPORT (www.olapreport.com/Market.htm) and Corporate Performance Management (CPM) systems.

There are number of business intelligence systems which provide portals to enable users to view analyses.

Some of these portals, like SAP's Workplace and Brio Portal, enable the customisation of portals for different types of users.

Workflow tools are GUIs provided to enable users to create flow diagrams for a certain process. Each of the flow diagram components either requires user input or executes a specified action.

Workflow tools have been used within the business intelligence industry to drive data flow into the first tier databases. An example of such use is Microstrategy Transactor.

Workflow tools have also been developed to enable organisations to define electronically their day-to-day business processes such as supply chain management.

Often organisations have the need for particular analyses to be generated at a certain time, for example monthly reports.

Organisations may also require additional analyses to be undertaken depending on results from preceding analyses.

What is needed is a system to assist organisations to define customisable workflows of their business intelligence processes and to enable the users within those organisations to easily execute those workflows.

It is an object of the present invention to provide a method and system for integrating workflow management with business intelligence which satisfies the above needs or to at least provide the public with a useful choice.

### SUMMARY OF THE INVENTION

According to a first aspect of the invention there is provided a method to define a workflow for processes including the steps of:

i) specifying a plurality of processes within a GUI wherein one or more of the processes includes a business intelligence module; and

ii) specifying a plurality of directed links between the processes within a GUI.

The business intelligence module may be an input module, budget adjustment tracking module, journaling module, eliminator module, management & financial reporting module, or data load module.

The module may extract data from databases such as a relational database and/or multidimensional database through the use of any one or more of a MOLAP (Multidimensional OnLine Analytical Processing), ROLAP (Relational OnLine Analytical Processing), HOLAP (Hybrid OnLine Analytical Processing), or JOLAP (Java OnLine Analytical Processing). Data may have been compiled into the preceding databases from a data warehouse.

The processes may include a script written in a scripting language such as JavaScript. The script may specify the execution of actions such as the execution of the module.

The processes and links may be represented visually within the GUI like a flowchart.

One of processes may be specified as the start of the workflow. Another of the processes may be specified as the end (or last process) of the workflow.

The links may include logic elements such as AND, OR, and XOR. These logic elements may be configured to use data resulting from the processes, from which the link is outbound, to give the link a condition.

According to a further aspect of the invention there is provided a method of executing processes in a workflow including the steps of:

i) displaying a plurality of processes within a GUI wherein one or more of the processes includes a business intelligence module;

ii) displaying a plurality of directed links between the processes within the GUI; and

iii) executing in sequence at least one of the processes.

The business intelligence module may be an input module, budget adjustment tracking module, journaling module, eliminator module, management & financial reporting module, or data load module.

The module may extract data from databases such as a relational database and/or multidimensional database through the use of any one or more of a MOLAP, ROLAP, HOLAP, or JOLAP. Data may have been compiled into the preceding databases from a data warehouse.

The processes may include a script written in a scripting language such as JavaScript. The script may specify the execution of actions such as the execution of the module.

The processes and links may be represented visually within the GUI like a flowchart.

One of processes may be specified as the start of the workflow. Another of the processes may be specified as the end (or last process) of the workflow.

The links may include logic elements such as AND, OR, and XOR. These logic elements may be specified to use data resulting from the processes, from which the links are outbound, which gives the link a condition.

The process may have to be actuated by the user, for example by the user clicking on the visual representation of the process, for the process to execute.

Before the process is executed the conditions of all the links inbound to the process may have to be satisfied.

After the process is executed data resulting from execution may be used by outbound links to determine their conditions.

According to a further aspect of the invention there is provided a method of operating a computer system whereby operation is driven by selection and execution of a workflow item from a plurality of menu items and during said execution a business intelligence module is called.

The menu items may be displayed within one portion of the GUI, preferably in a menu list on the left-hand side of the screen, and the workflow, when selected, may be displayed in another portion of the GUI, preferably in a window on the right-hand side of the screen. The menu items may include a plurality of workflow items. The menu

items may include folder items with a folder icon. The workflow items may be arranged within a tree-structure of folder items.

When the workflow is selected and displayed it may be executed in accordance with the method of the second aspect.

According to a further aspect of the invention there is provided a system for analysing data comprising:

i) a database system;

ii) a business intelligence engine adapted to analyse data within the database system; and

iii) a workflow management GUI responsive to user input to define a workflow for processes and adapted to execute processes in a workflow wherein at least one of the processes uses the business intelligence engine to analyse data.

The business intelligence engine may include online analytical processing tools (OLAP) such one or more of a MOLAP, HOLAP, ROLAP, or JOLAP.

### BRIEF DESCRIPTION OF THE DRAWINGS

The invention will now be described by way of example with reference to the accompanying drawings in which:

FIG. 1: shows a use case model of the invention.

FIG. 2: shows a diagram illustrating a standard process.

FIG. 3: shows a diagram illustrating links between processes.

FIG. 4: shows a screenshot illustrating a GUI screen for workflows.

FIGS. 5 to 15:

show screenshots illustrating an example of the invention wherein a workflow for Monthly Data Collection is defined.

FIGS. 16 to 24:

show screenshots illustrating the above example wherein the workflow is executed.

FIGS. 25 to 30:

show screenshots of business intelligence modules.

### DETAILED DESCRIPTION OF PREFERRED EMBODIMENTS

The present invention relates to a method and system for integrating workflow management with business intelligence.

The Work Flow Module (WFM) invention provides a central repository from which business intelligences modules can be accessed, and allows the flow of tasks through the different business intelligence modules to be managed.

WFM allows process flows to be developed that control how and when a user accesses a module, and the tasks that they perform in the module. For example, controls can be set to ensure that tasks only occur at specified times, or that one task cannot be started until the previous task has been completed.

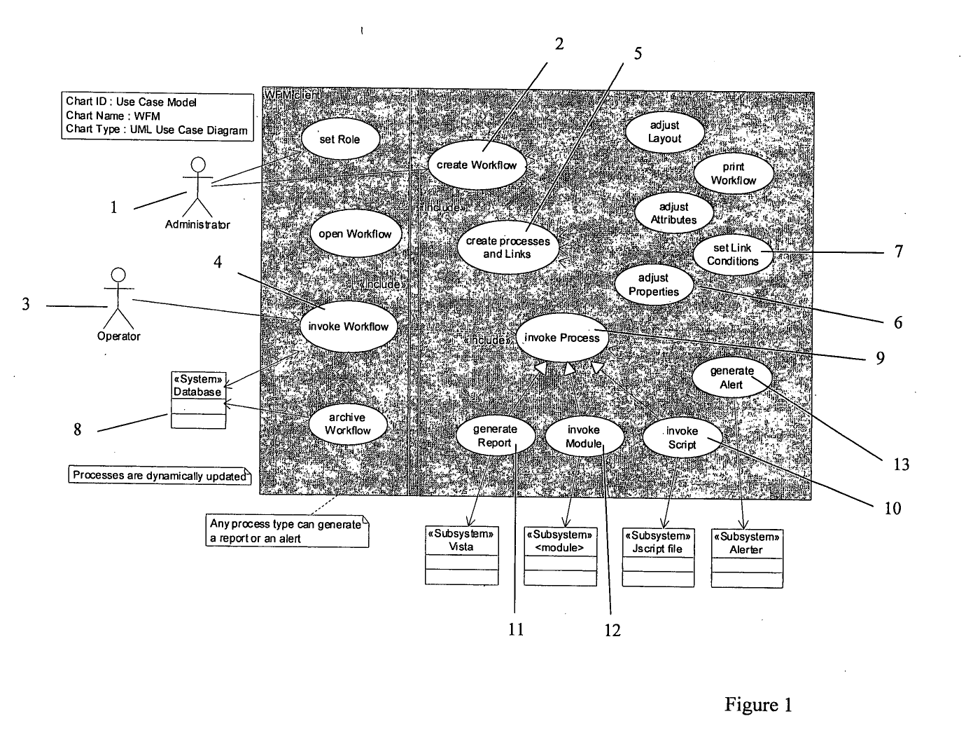

FIG. 1 is a use case model showing how actors interact with the system.

In this embodiment of the invention an Administrator 1 user type has the ability to create Workflows 2 and an Operator 3 user type has the ability to invoke Workflows 4.

The administrator in creating the workflow 2 can create Processes 5 which have Properties 6 which specify actions to be undertaken when the Processes are executed.

The administrator may also create links 5 between the processes. Each link may have conditions 7 associated with it which determine if the process to'which it links to may execute or not.

The user may invoke Workflows 4 created by the Administrator from the System Database 8. Each workflow is composed of a number of processes and links. The user may invoke the processes 9 contained within the workflow. Invocation of each process is dependent on the satisfaction of conditions within the links which are inbound to that process.

Each process can invoke a script 10 such as JavaScript, generate a report 11, invoke a module 12 such as a business intelligence module, or generate an alert 13.

After the workflow has been invoked by the user it can be archived to the System Database 8.

In these examples the WFM is implemented as a Java Applet that is used in a web browser. Web browsers that can be used include Internet Explorer and Netscape Navigator.

In this embodiment of the invention the WFM uses the Relational Database Management System (RDBMS) to store information.

Workflow

A workflow is group of tasks (processes). The WFM provides the ability to link the processes to represent the flow of work to be followed to complete a high-level task. When processes are linked and become sequential, conditions can be set to control when a process can be performed, and who can perform the process.

A workflow is created by an administrator and performed by a user.

Each workflow can be performed by a user only once. Once the processes in the workflow have been performed, they become inactive. Processes that need to be run multiple times can be created as a template. Each time the process needs to be run, the template is saved as a new workflow and the user performs the processes on the newly saved workflow.

Creating Workfilow Templates

A workflow can be saved as a template to allow future workflows using the same base processes and links to be created quickly and easily. For example, if the same workflow is used at the end of every month, but some controls set in the workflow are based around dates, a workflow template can be created and used to create a new workflow for each month. In this situation all that is required to have the new workflow ready for use, is the modification of the control dates.

Processes

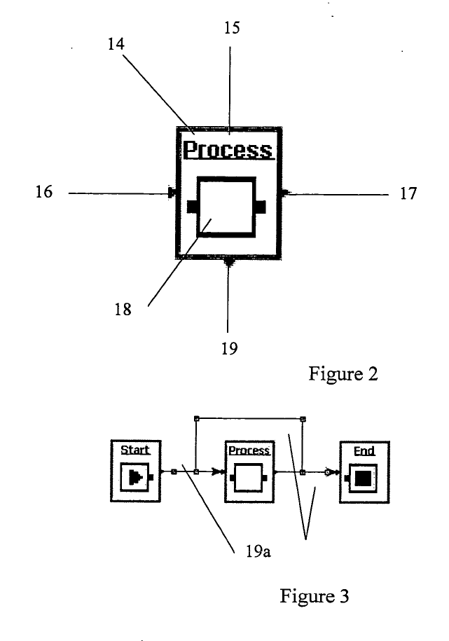

Referring to FIG. 2, a standard workflow process will be described.

Processes represent the tasks within a workflow. Processes can be linked together to form a sequential process, or workflow.

Processes need to be added to a workflow to allow users to perform tasks such as opening a Client Input Module (CIM) view, loading data through the Data Load Module (DLM) or using VISTA for reporting.

Processes are visually represented in a workflow by a series of icons.

A process has a label 14 which summarises what the process does, an outline 15 which may be coloured depending on status, an in port 16 which inbound links are connected to, one or more out ports 17 which outbound links are connected to, an icon 18 which identifies the type of process, and a system port 19 which is connected to the system process.

There are five general process types:

1. Start—A process with no in ports, and one out port.

2. Standard—A process with one in port and one out port.

3. End—A process with one in port and no out ports.

4. Multi-choice—A process with one in port and two out ports.

Note: A standard process can be linked to more than one following process, however the multi-choice process displays linking to more than one following process in a way that makes it easier to see the links.

5. System—A process that represents the entire workflow. This process is always hidden unless the Workflow properties and attributes are modified to make the process visible.

This process is used to control the security (roles) that can access processes within a workflow, and the dates on which processes can be run.

Process Ports

Each process has one or more ports. A port is a connection point for the process. Processes are connected to each other via links that connect to the process ports. There are three different types of ports that can appear on a process:

1. In port—A port that allows the process to be connected to a prior process. For example, when Process A's in port is connected to Process B, it indicates that Process B occurs before Process A in the workflow.

The in port always appears on the left of the process icon.

2. Out port—A port that allows a process to be connected to a following process. For example, when Process A's out port is connected to Process B, it indicates that Process A occurs before Process B in the workflow.

The out port always appears on the right of the process icon.

3. System port—A port that is used to connect the process to the system process. All processes are automatically connected to the system process.

The system port always appears at the bottom of the process icon.

The system port is only visible when the system process is displayed.

Process Actions

All processes remain inert on a workflow until a user performs an action against the process. Users can perform two actions against a process: invoke process, and finish invoked process. The first action will cause the process to run, the second will indicate that the process is complete. Both of the actions will change the status associated with the process.

Process Tags

Each process has two default tags associated with it—JavaScript and status. The JavaScript tag allows JavaScript to be used to control what the process does when a user invokes the process. The status tag holds the current state of the process. A process is automatically assigned one of four statuses based on the actions performed against the process by a user. There are four default process statuses:

1. Not started—The process is added to a workflow.

2. In progress—A user invokes the process.

3. Failed—A user sets the status to Failed. For example, this status could be applied programmatically to indicate when a CIM validation has failed.

4. Completed—Completed

Process statuses can be used as conditions to indicate when the next process in the workflow is performed. These conditions are set up on the links in a workflow. For example, a condition could be set on a link to control the workflow so that the second process in the flow isn't started until the first process has been completed.

Links

Referring to FIG. 3, links will be described.

Adding links 19a between the processes in a workflow indicates the order in which the tasks (processes) should be performed. As many links as are required can be added to connect processes in a workflow.

Links can be formed between processes in the following way:

1. Click and hold down the mouse button on the out port of the process you are linking from.

2. Drag the out port to the in port of the process to which you are linking. The mouse pointer will turn into a small pointing hand, and a black line will appear between the two processes.

3. Release the mouse button. The link will change colour and remain selected.

Modifying links in a workflow

The properties of a link define the way that a link functions. For example, link properties include the conditions must be met before the next process can be performed.

JavaScript

JavaScript can be utilised to add more advanced controls and functionality to the WFM. JavaScript can be added to the properties of workflows, links and processes. Examples of how an administrator may use JavaScript in a workflow include:

Sending an email/alert to a user to indicate when a process has been completed.

Prompting a user with a text message to remind them to complete a task.

Obtaining a set of data from the database.

Generating reports, or obtaining a validation status within a CIM view.

The administrator can write the JavaScript themselves or load the JavaScript from a predefined file (library).

The following sections describe how the JavaScript may be used to launch various modules:

Open a Business Intelligence Module

The following example launches the Data Load Module (DLM).

| | |
|---|---|
| function processFn( process ){ | Standard function opener |
| port = 27052 | The port on which the DLM is |
| | located |
| host = “localhost” | The host on which the DLM is |
| | located. This and the previous |
| | line set up the module proxy. |
| myModule = newIDLM(host,port) | Sets a variable called myModule |
| | that contains the DLM proxy |
| | information. |
| myModule.show( ) | Displays the DLM in a separate |
| | window. |
| } | Standard function closer. |

Open a CIM View

The following code is an example of how to launch a CIM View called Month End that is within a folder called Month End Views.

| | |
|---|---|
| function processFn( process ){ | Standard function opener |
| port = 27050 | The port on which the CIM is |
| | located |
| host = “localhost” | The host on which the CIM |
| | is located. This and the |
| | previous line set up the |
| | module proxy. |
| myModule = newICIM(host,port) | Sets a variable called |
| | myModule that contains the |
| | CIM proxy information. |
| view = “Month End Views/Month End” | Sets the variable view with |
| | the view file and pathname. |
| showView(myModule.view) | Displays the CIM view in a |
| | separate window. |
| } | Standard function closer. |

Generate a CIM Report Based on a User Selection

The following code generates a CIM report. The report generated will be the report selected by the user from a list of all of the available CIM reports.

| | |
|---|---|
| function processFn( process ){ | Standard function opener |
| port = 27050 | The port on which the CIM is |
| | located |
| host = “localhost” | The host on which the CIM |
| | is located. This and the |
| | previous line set up the |
| | module proxy. |
| myModule = newICIM(host,port) | Sets a variable called |
| | myModule that contains the |
| | CIM proxy information. |
| list = myModule.executeQuery(“SELECT | Sets the variable list as an |
| report_desc FROM cim_reports”) | array containing the |
| | available CIM reports. |
| report = promptx(“Please select | Displays a dialog requesting |
| the report you would like to run”, | that the user selects the CIM |
| list, null) | report that they want to run, |
| | from the list of reports held |
| | in the list variable. The |
| | result (report to be run) is |
| | stored in the report variable. |
| MyModule.generateReport(report) | Runs the required report in |
| | the CIM module. |
| } | Standard function closer. |

Performing a Process

Once a workflow has been set up by an administrator, with all the required processes and links, the processes can be performed (invoked) by a user. Processes can only be invoked when the conditions set to control the process, are met.

When a process is selected a status panel provides information detailing whether the process can be invoked.

A process is invoked by a user in the following way:

1. Selecting the process that is to be performed.

2. Choosing to invoke the process:

Either by clicking on the invocation button on the toolbar, selecting Tools>invoke process from the menu, or clicking with the right mouse button on the process and selecting invoke process from the shortcut menu.

When a process is invoked the process status automatically changes to In Progress.

Completing a Process

The user will need to indicate to the WFM when a process has been completed. Indicating the completion of a process allows the process status to be updated.

The user can indicate completion of a process by:

1. Selecting the process that has been completed.

2. Choosing to finish the invoked process:

Either by clicking on the finish process button on the toolbar, selecting tools>finish invoked process from the menu, or clicking with the right mouse button on the process and selecting finish invoked process from the shortcut menu.

When an invoked process is finished the process status automatically changes to Complete.

The Workflow Screen

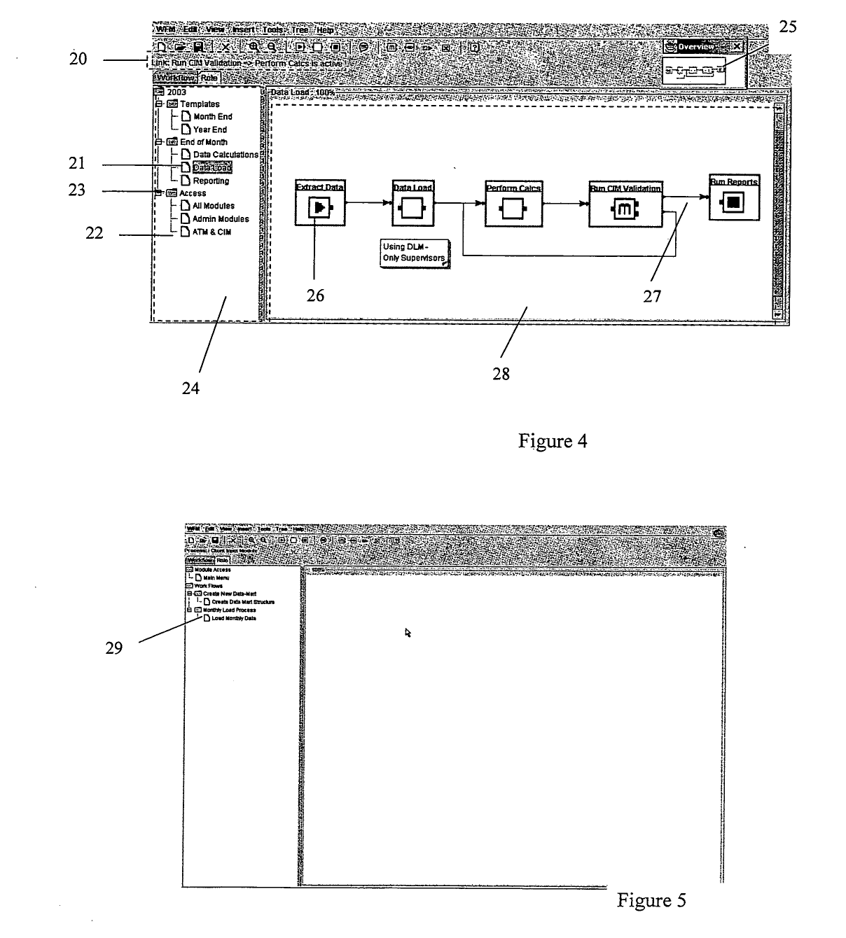

FIG. 4 shows the workflow screen.

The workflow screen provides the ability to add, modify and delete workflows.

The status panel 20 displays information regarding the object 21 that is currently selected.

The saved workflows 22 are workflows and workflow templates that have been saved. The saved workflow items can be structured within folders 23.

The workflow tree 24 is a visual display of the hierarchy of existing workflows, workflow templates and folders.

The overview window 25 is a small thumbnail representing the entire workflow process that is currently open.

A process 26 is a task or set of tasks within the workflow.

A link 27 is a connection between processes in a workflow. Links define the sequence, or flow, of processes.

The workflow display area 28 is the area of the screen in which workflows are displayed.

### EXAMPLE 1

FIGS. 5 to 24 show the generation and invoking of a work flow for monthly budget data collection.

FIG. 5 shows a screenshot of the workflow screen for the workflow management GUI (WFM).

The WFM is opened and a new workflow is created by an administrator, currently the workflow is empty with no processes created. Note that the workflow appears in the workflow tree to the left named Load Monthly Data 29.

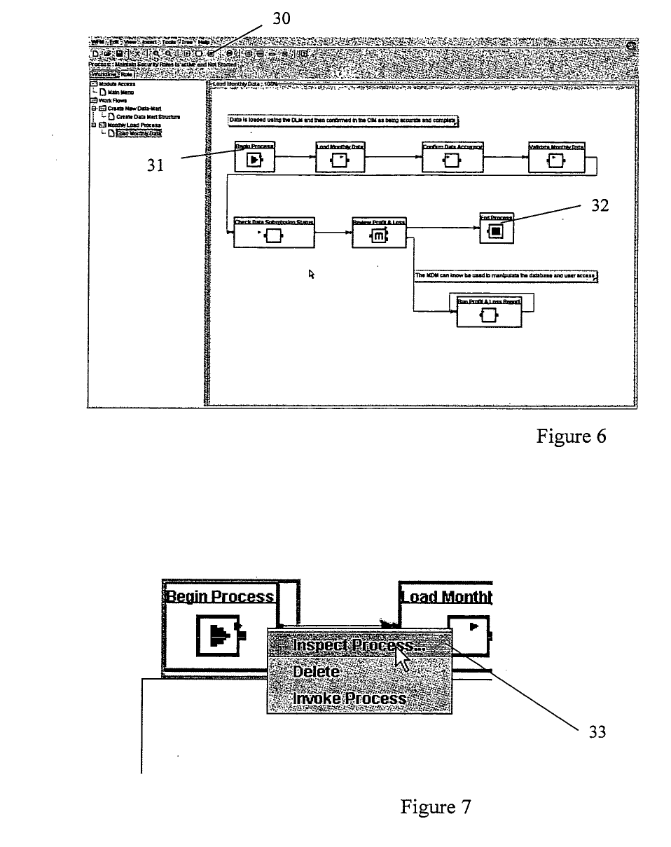

FIG. 6 shows a screenshot of the workflow after processes and links have been created.

The administrator pressing the toolbar buttons 30 within the GUI and adjusting the processes position on screen via drag and drop have now created many processes. There is a “start” process 31 in the upper left and an “end” process 32 in the lower right, all the other processes are standard processes containing “in” and “out” ports. Each out port has been connected with an appropriate in port to visually indicate the “low” through the workflow.

The label of each process has been given an appropriate name for the step in question.

FIG. 7 shows a portion of the workflow GUI when the administrator has selected the right click menu on the first process. The processes are defined by first selecting the inspect process option on the right click menu.

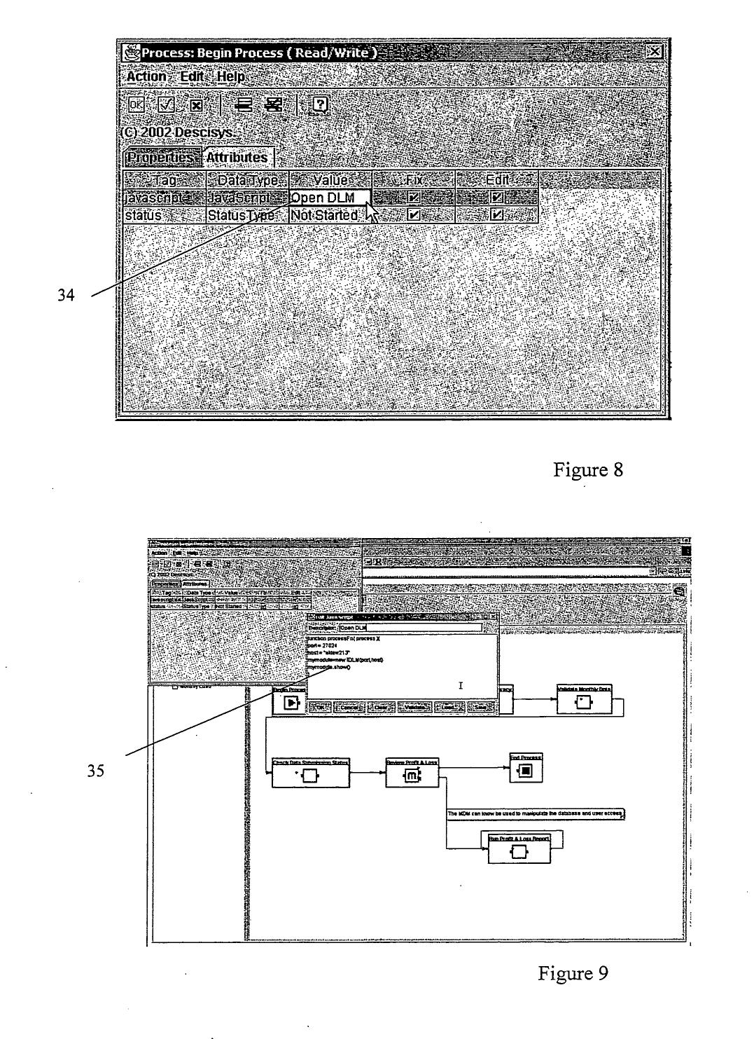

FIG. 8 shows the attribute window for a process wherein tasks may be defined for execution.

The Process attribute window is displayed when the inspect process option is selected and the JavaScript property 34 that will define the behaviour of the process when it is invoked by the user can be edited.

The editor 35 for the JavaScript is shown in FIG. 9. The script shown is a simple action of opening a business intelligence Data Load Module for initial data loading.

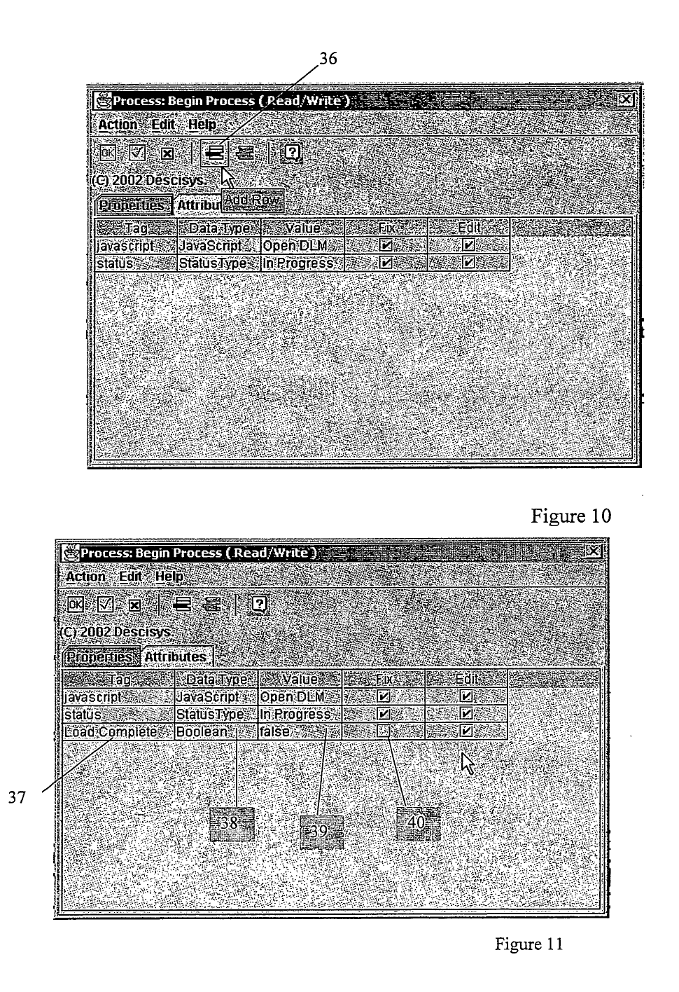

FIG. 10 shows the attribute window for the process. To add a new property for the process such that the data load module can indicate that it has completed satisfactorily the new property button 36 is pressed.

FIG. 11 shows the attribute window with a new property is added and named Load Complete 37. Its type 38 is Boolean (true/false) and is given an initial value 39 of false. The Fix variable 40 is set to off so the Data Load Module can set the value of the property to true when it is satisfied.

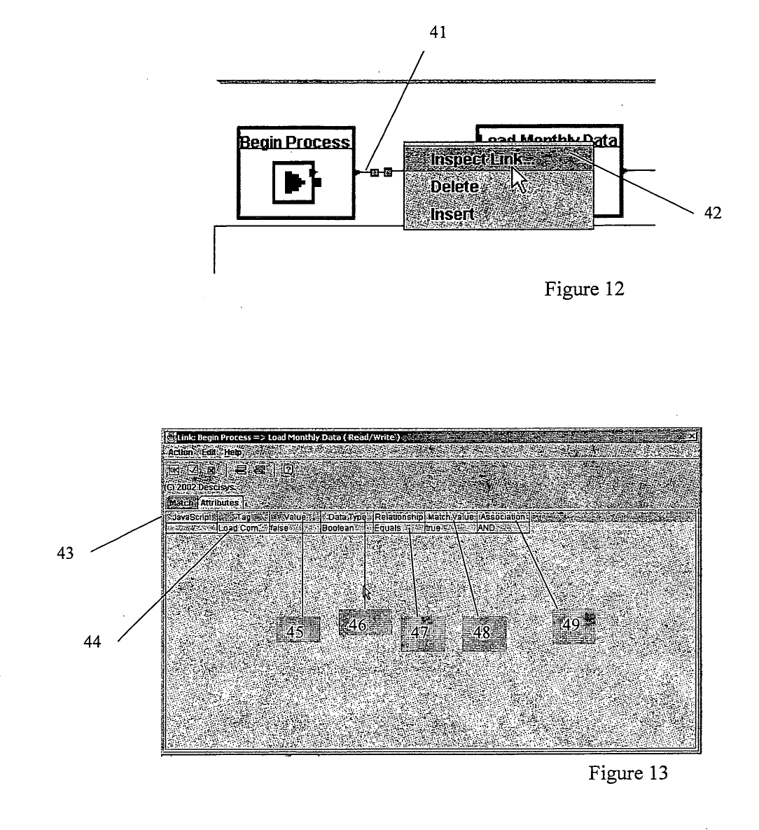

FIG. 12 shows a portion of the workflow GUI when the administrator has selected the right click menu on the link between the first and second processes.

The Load Complete value will be used to enable the next process when it is set to be true, so that the user cannot move on until they have loaded data successfully. The way this is controlled is via the “link” 41 between the first process and the next process. To do this the first step is to inspect 42 the link.

FIG. 13 shows the link's attributes.

A new attribute row 43 is added to the link's attributes.

It is based on the value of the Load Complete 44 property from the process on the in part of the link. The current value is shown under Value 45, the data type is shown under Data Type 46, the relationship 47 to the match value is shown and the “required” value 48 is shown. In this example when the input value is equal to true the link is considered active. The Association field 49 is used when there is more than one required value to make the link active.

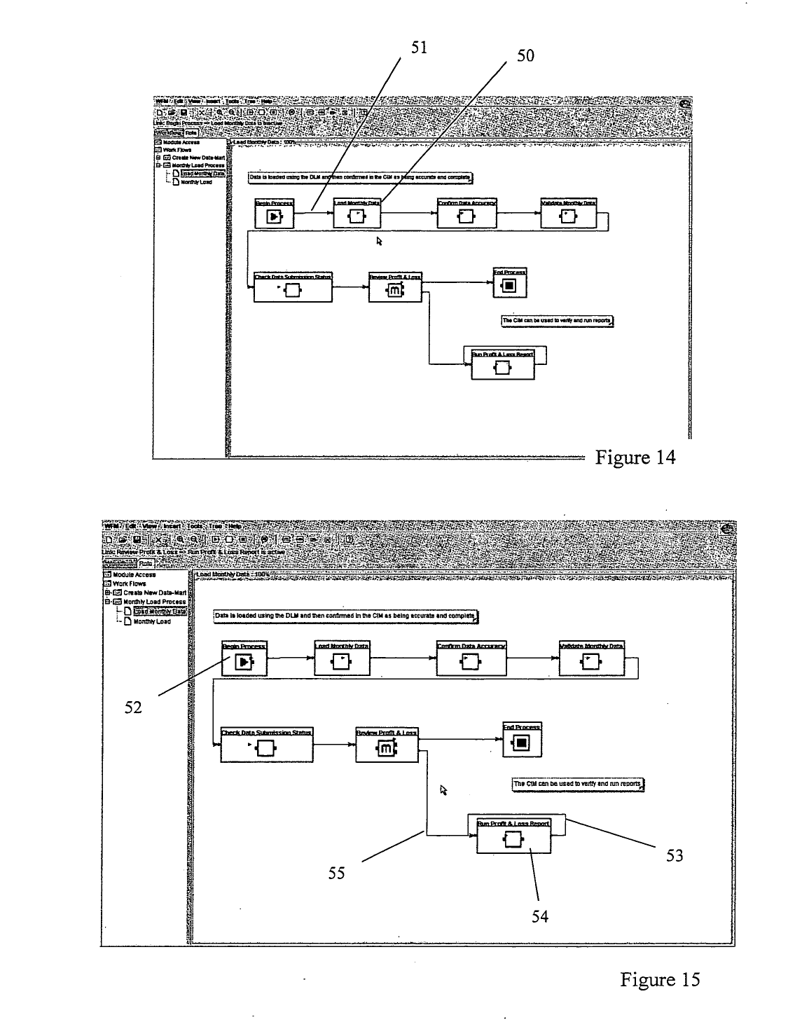

FIG. 14 shows the workflow where the second process 50 has become “disabled” as it has a link 51 that is disabled because its requirement that the input value is true has not been met. Once this workflow is invoked the first process will set the Load Complete value to true and hence the link will enable the second process so that it may be invoked.

FIG. 15 shows the workflow when each process is set to require that the previous process is complete before it becomes enabled. Note that the start process 52 is the only process that is not currently “disabled” this gives the start point for the flow. Note also that the loop back link 53 on the Report process 54 is still blue but because the other link 55 to the process is not enabled the process is not enabled.

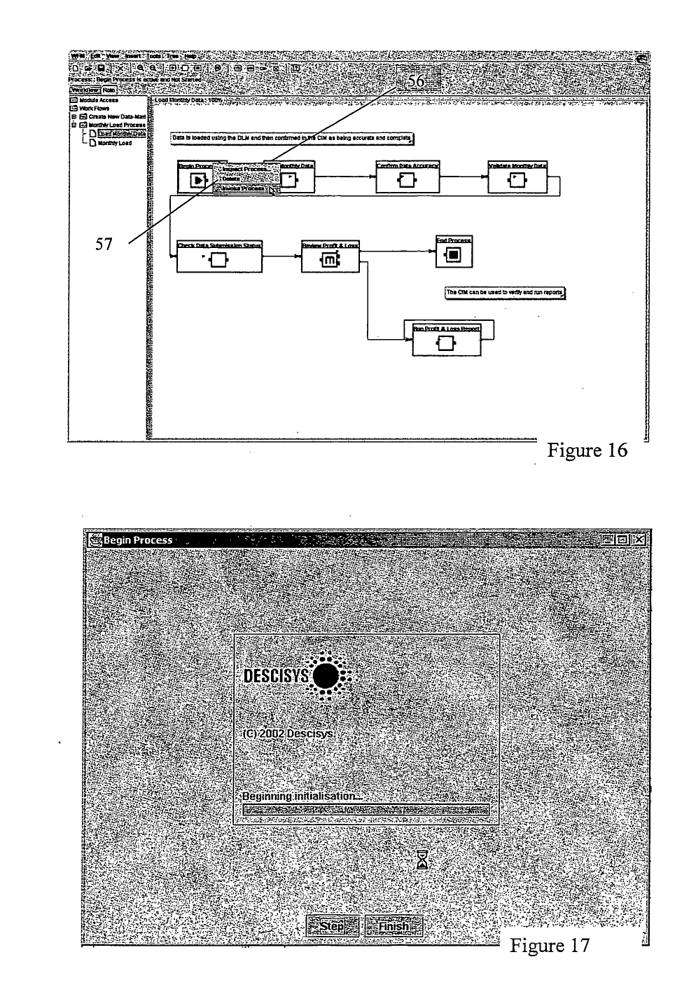

FIG. 16 shows the workflow when a user is invoking the workflow.

The first process is invoked by using the right click menu 56 and selecting invoke process 57.

FIG. 17 shows the load up screen for the Data Load Module.

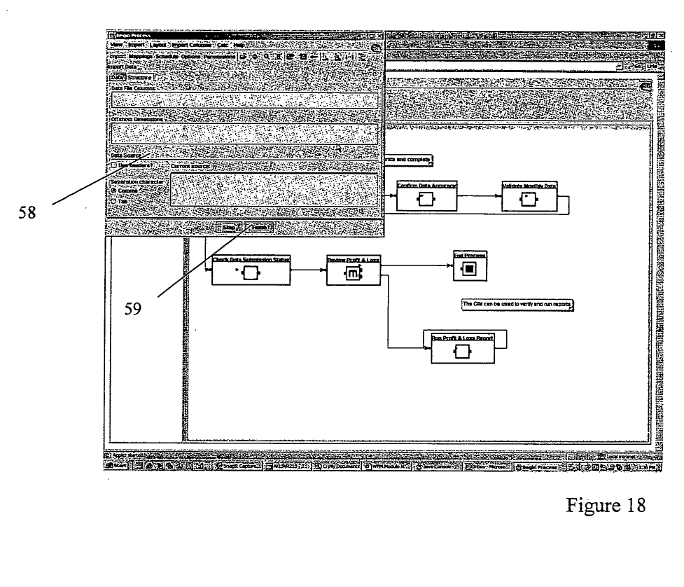

FIG. 18 shows a window 58 wherein the Data Load Module is running. When the user is finished with the Data Load Module they press the finish button 59 and the module is removed from the screen.

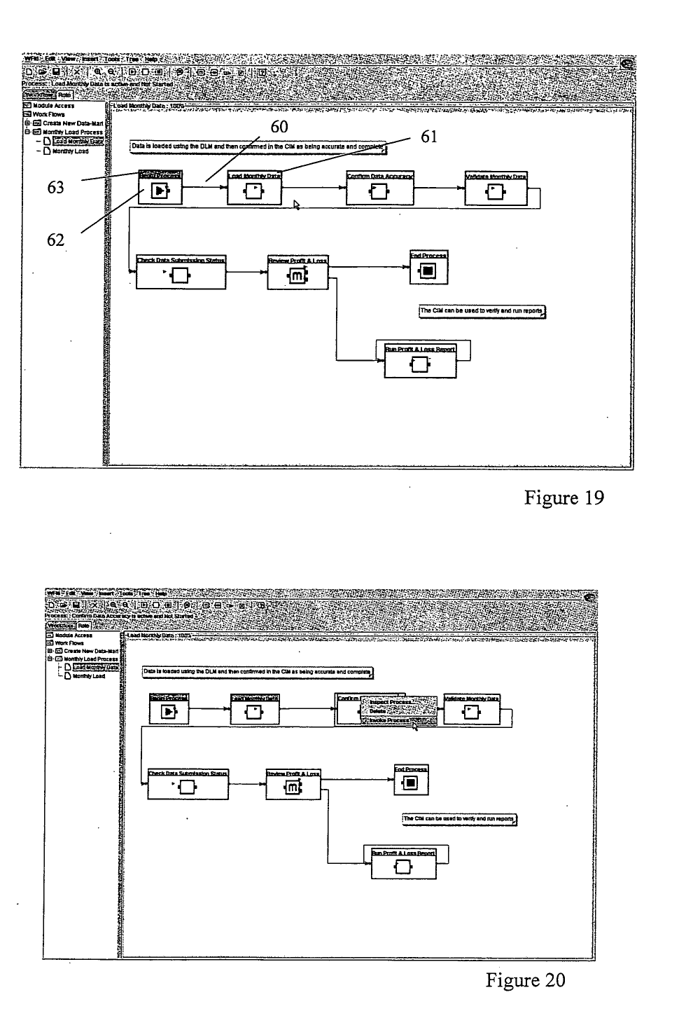

FIG. 19 shows the workflow after the Data Load Module has successful executed.

The user finishes loading the data and the Data Load Module is removed. The load complete value on the link 60 is now set to true and the next process 61 is now active and the first process 62 is now “complete” and is no longer accessible to the user.

The link 60 between the first 62 and second 61 processes changes colour to blue to indicate that its conditions—in this example that Load Complete equals true—are satisfied.

The outline of the first process changes back to red and the background colour of the label 63 changes to green to indicate that it has finished execution.

The outline of the second process has changed colour from red (disabled) to blue to indicate that it may be invoked by the user.

FIG. 20 shows the workflow after the Load Monthly Data process has successfully executed. The next module along is invoked and an input module to maintain the data is started.

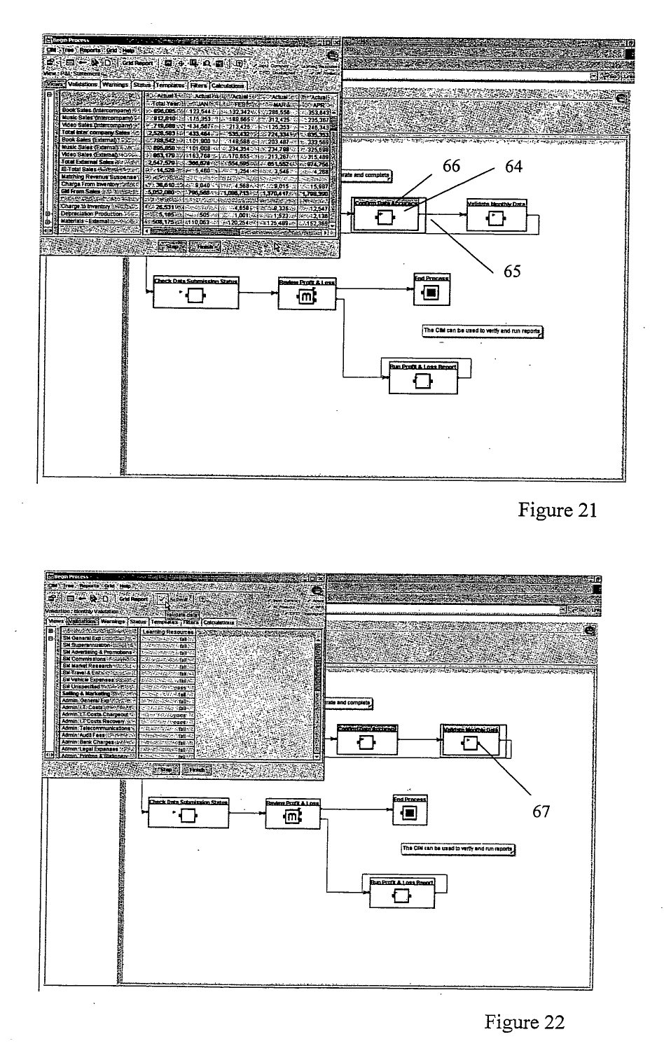

FIG. 21 shows the execution of the Confirm Data Accuracy process 64.

When a process is currently executing a green box 65 surrounds the process and the background colour of its label 66 is changed to light blue.

FIG. 22 shows the workflow when the Validate Monthly Data process is executing.

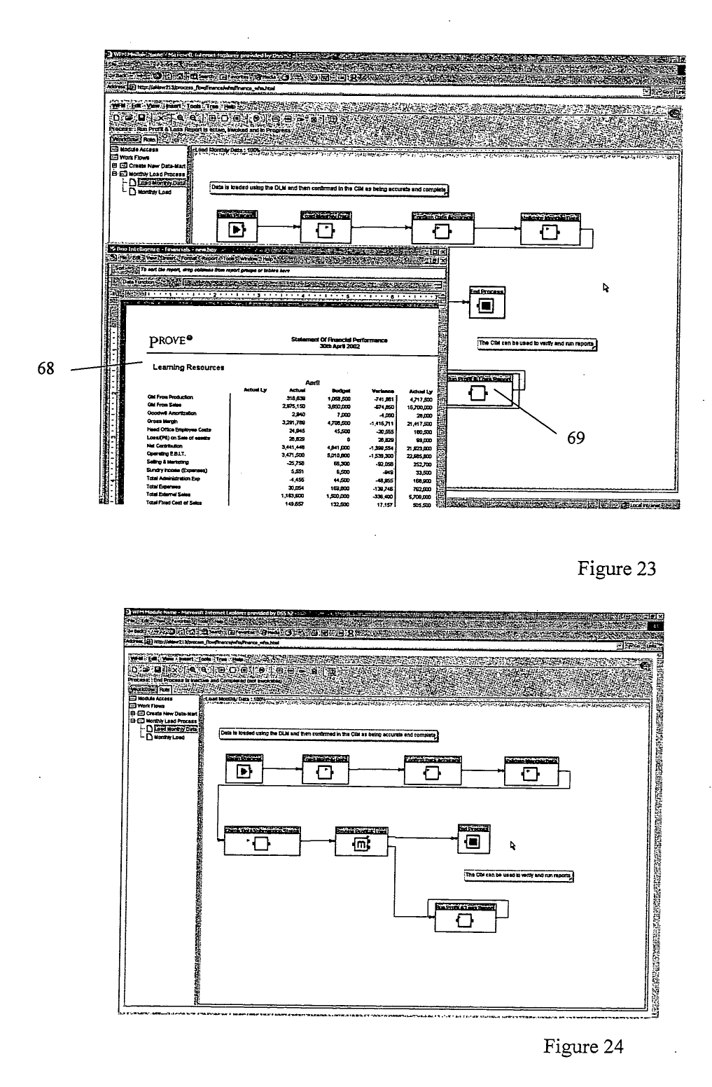

FIG. 23 shows the workflow when a report 68 has been run using the Run Profit & Loss

Report process 69. As this process has a loop back to itself it may be invoked as many times as is desired until the workflow is finally finished by invoking the end process.

FIG. 24 shows a completed workflow.

Business Intelligence Modules

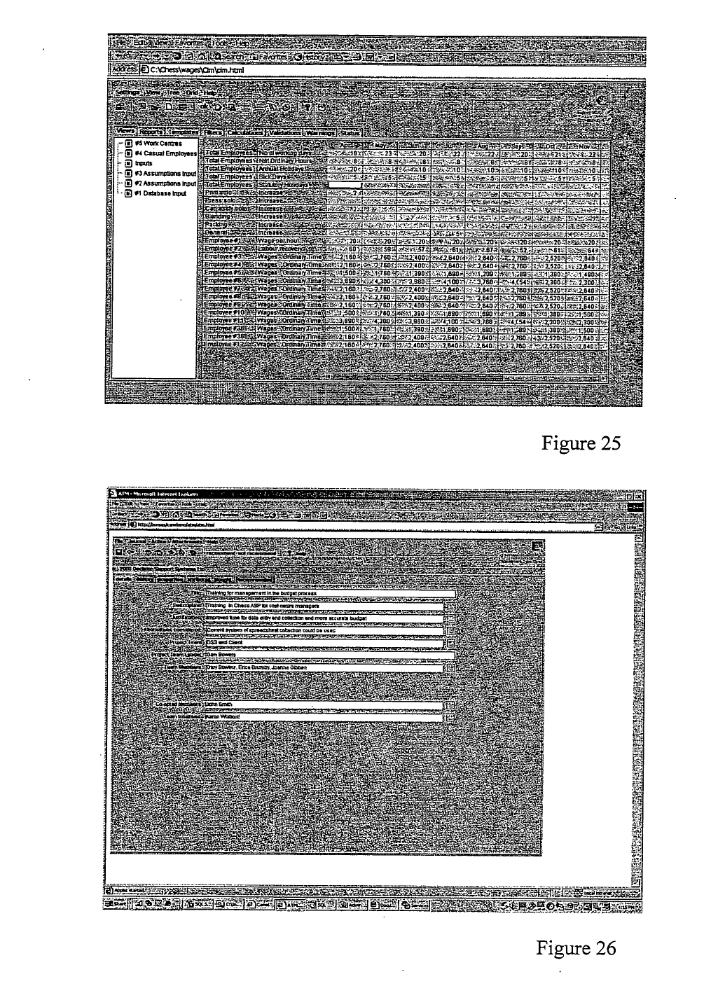

FIGS. 25 to 30 give examples of various business intelligence modules that may be invoked by the processes within the workflow.

Input Module

FIG. 25 shows a screenshot of an Input Module.

The Input Module provides a means to enter, calculate and efficiently build up a budget or forecast for a department or business unit of a corporation. The Input Module performs validations and prompts users to review data that might not comply with defined rules, so that data submitted by the users is clean. Corporate Finance users in the corporation can review and report on the entered data.

To aid the process of entering, viewing and analysing budget, forecast, actual and variance data, the Input Module has a user definable viewer that can be configured by the administrator or users to layout their screen formats. The screen view is the familiar grid-style with columns and rows colour-coded to highlight read only total lines and columns versus read/write columns and rows.

Data entry screens can be designed to utilise dimensional data in more than one budget model. For example, products and services could be set up to develop and calculate a sales budget or forecast, or human resources to derive salaries and wage budgets. Business assumptions and drivers are set-up to automate the process of budget/forecast development delivering results more quickly and accurately for the department users.

For example, consider a wages budget. The business drivers associated with calculating wages for a department or individual within that department may be the number of working days in the month and wage rate changes.

Adjustment Tracking Module

FIG. 26 shows a screenshot of an Adjustment Tracking Module.

The Adjustment Tracking Module (ATM) provides the capability of tracking and authorising changes to budgets throughout the life of the budget, through the budget development and budget management phases. The Business Unit and Corporate Finance users use this module to manage budget variations or strategic initiatives.

Business units are able to enter transactions on-line and update them when necessary.

The ATM can record transactions against a specific level within the Chart of Accounts. This level can be configured to be any level within the Chart of Accounts (or indeed a combination of members from various levels).

An adjustment will progress through various stages during its life cycle to enable approval processes to be implemented. At each stage, the data contained within the adjustment can be updated and new details included.

A business could use ATM to track strategic initiatives and model their impact on the baseline operational budget.

Journaling Module

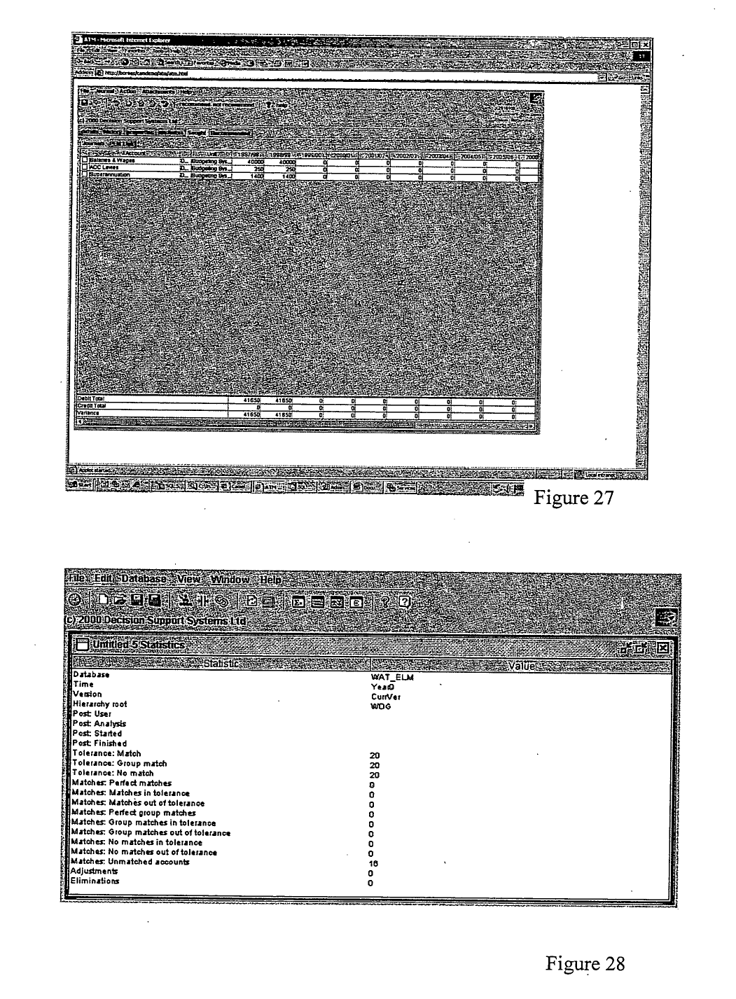

FIG. 27 shows a screenshot of a Journaling Module.

The Journaling Module provides the ability to post and report on double entry journals to budget and actual data held in the database in order to provide an audit trail of changes to account balances. The system is used by corporate finance to manage changes to financial data.

The Journaling Module (JM) has been provided to allow users to make adjustments to a department's data and provide an audit trial of each modification

Eliminator Module

FIG. 28 shows a screenshot of an Eliminator Module.

The Eliminator Module provides the ability to identify discrepancies in posting transfer entries between counter parties. The module has the option to generate automatic journals within a specified tolerance.

Where accounting transfers are required between Business Units, discrepancies can occur, as each party does not record the same entry in their books. As a result, when Corporate Finance consolidate a company group position, these discrepancies must be eliminated.

Counter Party details are entered into the system via two methods:

When entries are made to the ATM for adjustments, the system requires the user to enter the Counter Party identifier for each leg of the entry. On approval, ATM writes the Accounts to the Budget Approval version.

When entities are inputting their Budget version through the input application, the system requires the user to enter a Counter Party identifier against each line.

The Counter Party identifier entries create the input to the Eliminator module. Where no material difference occurs between the balances, the system will create reversing entries at appropriate levels in the hierarchy. This process is completed successfully when all entries are eliminated at the company group level.

Eliminations can be performed at user-selected levels.

Reporting Module

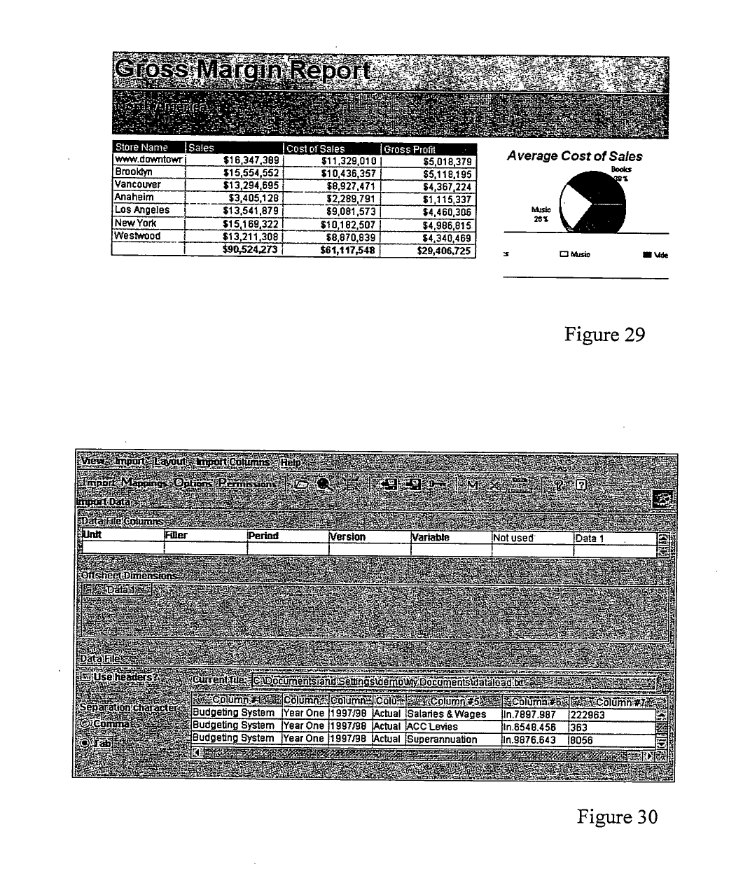

FIG. 29 shows an example of report produced by the Reporting Module.

The Reporting Module delivers integrated reporting that meets query, analysis and reporting needs.

With a minimum of training company staff will be able to develop and deliver financial and non-financial reporting to the entire organisation.

Data Load Module

FIG. 30 shows a screenshot of a Data Load Module.

The Data Load Module (DLM) facilitates the loading of files to the business intelligence engine's databases using pre-formatted mapping layouts. Typically, the source data and structure will be from a General Ledger system or “Line of Business” transaction systems and will consist of many records, similar to that used in a batch load.

The standard DLM Process consists of the following steps:

1. Load and read the external Data file.

2. Select the Layout required to match the file type.

3. Select and configure Dimension Members.

4. Confirm how the data will be read.

5. Analyse the data.

6. Load the data and confirm the load options.

Advantages

It is critical when deploying BI analysis applications that users utilise the functionality available in a consistent way when performing analysis, submitting additional data or information for review and/or acceptance, and producing outputs which will be used for decision making. The invention ensures that the same sequence of modules, and commands within modules are used, to ensure that the use of the analytical application is both correct and consistent across all users, thereby ensuring consistent outputs, whilst allowing organisations to tailor the sequence of usage to meet their specific business need.

Secondly, by ensuring that complicated BI analysis is performed correctly, the amount of staff time involved is reduced through users not having to remember or discover what to do next, and also by reducing the amount of rework required if they follow an incorrect sequence. Further, this invention can produce consistently high quality outputs which ensures that decisions based on those outputs are unlikely to have to be revisited, and are more likely to be correct. Although this invention has been described by way of example it is to be appreciated that improvements and/or modifications may be made thereto without departing from the scope or spirit of the present invention. Furthermore, where known equivalents exist to specific features, such equivalents are incorporated as if specially referred to in this specification.

1. A method to define a workflow for processes including the steps of:
i) specifying a plurality of processes within a GUI wherein one or more of the processes includes a business intelligence module; and
ii) specifying a plurality of directed links between the processes within a GUI.

2. A method as claimed in claim 1 wherein the direct links contain logic elements.

3. A method as claimed in claim 1 wherein the business intelligence module is adapted to extract data from a database system.

4. A method as claimed in claim 3 wherein the business intelligence module is adapted to extract the data through any one or more of the set of MOLAP, ROLAP, HOLAP, and JOLAP.

5. A method as claimed in claim 4 wherein the database system is a data warehouse.

6. A method as claimed in claim 1 wherein one or more of the processes is a script.

7. A method as claimed in claim 6 wherein the script is in JavaScript.

8. A method as claimed in claim 6 wherein the business intelligence module is specified within one or more of the scripts.

9. A method as claimed in claim 1 wherein the processes are represented visually within the GUI by flowchart objects.

10. A method as claimed in claim 9 wherein the directed links are represented visually within the GUI by lines.

11. A method as claimed in claim 1 wherein at least one of the processes is a start process and at least one of the processes is an end process.

12. A method of executing processes in a workflow including the steps of:
i) displaying a plurality of processes within a GUI wherein one or more of the processes includes a business intelligence module;
ii) displaying a plurality of directed links between the processes within the GUI; and
iii) executing in sequence at least one of the processes.

13. A method as claimed in claim 12 wherein the direct links contain logic elements.

14. A method as claimed in claim 12 wherein the business intelligence module extracts data from a database system.

15. A method as claimed in claim 14 wherein the business intelligence module extracts the data through any one or more of the set of MOLAP, ROLAP, HOLAP, and JOLAP.

16. A method as claimed in claim 15 wherein the database system is a data warehouse.

17. A method as claimed in claim 12 wherein one or more of the processes are scripts.

18. A method as claimed in claim 17 wherein the scripts are javascripts.

19. A method as claimed in claim 17 wherein the business intelligence module is within one or more of the scripts.

20. A method as claimed in claim 12 wherein each of the processes is represented visually within the GUI by a flowchart object.

21. A method as claimed in claim 20 wherein the directed links are represented visually within the GUI by lines.

22. A method as claimed in claim 12 wherein at least one of the processes is a start process and at least one of the processes is an end process.

23. A method as claimed in claim 12 wherein execution of each process is dependent on user actuation.

24. A method as claimed in claim 23 wherein each of the processes is represented visually within the GUI by a flowchart object and the user actuation is actuation of the process's respective flowchart object.

25. A method as claimed in claim 13 wherein execution of each process is dependent on satisfaction of logic elements within all the directed links inbound to that process.

26. A method as claimed in claim 13 wherein at least one of the logic elements within at least one of the directed links is determined by the process from which the directed link is outbound.

27. A method of operating a computer system whereby operation is driven by selection and execution of a workflow item from a plurality of menu items and during said execution a business intelligence module is called.

28. A method as claimed in claim 27 wherein the menu items are displayed within a first portion of a GUI and the selected workflow items generate the display of an associated workflow within a second portion of the GUI.

29. A method as claimed in claim 28 wherein the associated workflow may executed in accordance with claim 12.

30. A method as claimed in claim 27 wherein the plurality of menu items includes a plurality of workflow items.

31. A method as claimed in claim 27 wherein at least one of the menu items includes an icon designating the status of that menu item.

32. A method as claimed in claim 27 wherein the menu items are organised in a list.

33. A system for analysing data comprising:
i) a database system;
ii) a business intelligence engine adapted to analyse data within the database system; and
iii) a workflow management GUI responsive to user input to define a workflow for processes and adapted to execute processes in a workflow wherein at least one of the processes uses the business intelligence engine to analyse data.

34. A system as claimed in claim 33 wherein business intelligence engine includes an OLAP to process data from the database system.

35. A system as claimed in claim 34 wherein the OLAP is one or more of the set of MOLAP, HOLAP, ROLAP, and JOLAP.

36. A system as claimed in claim 33 wherein the workflow may be defined according to claim 1.

37. A system as claimed in claim 33 wherein the workflow may be executed according to claim 12.

38. A system as claimed in claim 36 wherein the workflow may be executed according to claim 12.

39. A computer system for effecting the method of claim 1.

40. A computer system for effecting the method of claim 12.

41. Software for effecting the method of claim 1.

42. Software for effecting the method of claim 12.

43. Software for effecting the system of claim 33.

44. Storage media containing software as claimed in claim 41.

45. Storage media containing software as claimed in claim 42.

46. Storage media containing software as claimed in claim 43.
